(19) United States
(12) Patent Application Publication
(10) Pub. No.: US 2024/0405354 A1
(43) Pub. Date: Dec. 5, 2024

(54) GAS VENTING STRUCTURE FOR VEHICLE BATTERY PACK

(71) Applicants: Hyundai Motor Company, Seoul (KR); Kia Corporation, Seoul (KR)

(72) Inventors: Yu Ri OH, Hwaseong-si (KR); In Gook SON, Incheon (KR); Seok Eun YOON, Seoul (KR)

(73) Assignees: Hyundai Motor Company, Seoul (KR); Kia Corporation, Seoul (KR)

(21) Appl. No.: 18/383,172

(22) Filed: Oct. 24, 2023

(30) Foreign Application Priority Data
Jun. 1, 2023 (KR) 10-2023-0070758

(51) Int. Cl. H01M 50/358; H01M 50/258; H01M 50/383

(52) U.S. Cl. CPC H01M 50/358; H01M 50/258; H01M 50/383; H01M 2220/20

(57) ABSTRACT

A battery module includes a lower case accommodating a plurality of battery modules in a plane, a plurality of internal members provided to separate the battery modules accommodated in the lower case from each other, gas inlet holes formed in a predetermined number of the internal members to allow gas released from a battery cell of each of the battery modules to be introduced therethrough, and an external member disposed to receive the gas from end portions in the predetermined number of the internal members including the gas inlet holes and discharge the gas to the outside thereof.

### CROSS-REFERENCE TO RELATED APPLICATION(S)

The present application claims priority to Korean Patent Application No. 10-2023-0070758, filed on Jun. 1, 2023, the entire contents of which is incorporated herein for all purposes by this reference.

### BACKGROUND OF THE PRESENT DISCLOSURE

### Field of the Present Disclosure

The present disclosure relates to a technology for venting gases generated inside a battery pack mounted to a vehicle to the outside thereof.

### Description of Related Art

An electric or hybrid vehicle has a battery pack to supply power for driving a motor.

The battery pack includes a plurality of battery modules accommodated therein, and the battery modules each include a plurality of battery cells stacked on each other.

Each of the battery cells may ignite due to an impact or various other causes, in which case high-temperature gas released from the battery cell may become a medium for spreading fire to adjacent battery cells, resulting in a thermal runaway phenomenon in which the plurality of battery cells ignite in a chain.

Therefore, there is a demand for a technology that allows the gas generated by a battery cell to be rapidly discharged from the battery pack to the outside without spreading fire to adjacent battery cells or other battery modules.

The information included in this Background of the present disclosure is only for enhancement of understanding of the general background of the present disclosure and may not be taken as an acknowledgement or any form of suggestion that this information forms the prior art already known to a person skilled in the art.

### BRIEF SUMMARY

Various aspects of the present disclosure are directed to providing a gas venting structure for a vehicle battery pack, wherein a passage for independent and rapid discharge of gas released from a battery cell forming a battery module is provided to prevent the spread of fire to adjacent battery cells and adjacent battery modules as much as possible, greatly improving the fire safety of the battery pack.

To achieve the above aspect, a gas venting structure for a vehicle battery pack, according to an exemplary embodiment of the present disclosure, may include a lower case accommodating a plurality of battery modules in a plane, a plurality of internal members provided to separate the battery modules accommodated in the lower case from each other, gas inlet holes formed in a predetermined number of the internal members to allow gas released from a battery cell of each of the battery modules to be introduced therethrough, and an external member disposed to receive the gas from end portions in the predetermined number of the internal members including the gas inlet holes and discharge the gas outside of the external member.

The internal members may include a longitudinal member disposed to be elongated in a forward and rearward direction of the battery pack and a transverse member disposed to be elongated in a transverse direction, the gas inlet holes may be formed in the transverse member, and the external member disposed to receive the gas from an end portion of the transverse member and discharge the gas outside may be a pack side frame.

A cross-sectional structure of the transverse member in a direction perpendicular to a longitudinal direction thereof may include a shape in which the gas inlet holes are formed to be symmetrical to each other at first and second sides and an intermediate partition wall is disposed to separate the two gas inlet holes from each other.

The cross-sectional structure of the transverse member in the direction perpendicular to the longitudinal direction thereof may include a closed cross-section forming a separate space under the intermediate partition wall.

The intermediate partition wall may be elongated in an upward and downward direction in a center portion of the cross-sectional structure of the transverse member, and at least one reinforcement rib may be elongated in a horizontal direction under the intermediate partition wall.

At least one reinforcement rib may be elongated in a horizontal direction under the intermediate partition wall, and the intermediate partition wall may be shaped as a diagonal line bisecting a portion above the reinforcement rib in the cross-sectional structure of the transverse member.

A reinforcement rib may be elongated in a horizontal direction under the intermediate partition wall of the transverse member, a plurality of transverse members may be spaced apart parallel to each other in the forward and rearward direction of the battery pack, the pack side frame may be elongated in the forward and rearward direction of the battery pack to be connected to end portions of the plurality of transverse members, the pack side frame may include a vertical portion directly connected to the end portions of the plurality of transverse members and a horizontal portion protruding horizontally from the vertical portion to sides of the battery pack, and the reinforcement rib of the transverse member may be disposed at a height at which the reinforcement rib is aligned with the horizontal portion, to support a load externally applied through the horizontal portion.

The longitudinal member may include a center longitudinal member provided in a center portion of the battery pack, and side longitudinal members provided to be spaced apart on first and second sides from the center longitudinal member, the transverse members may be disposed to be symmetrically aligned with each other on first and second sides with respect to the center longitudinal member, and the center longitudinal member may be provided to seal the end portions of the transverse members.

In a cross-sectional structure of the transverse member in a direction perpendicular to a longitudinal direction thereof, a gas inlet hole may be formed in at least one side of the cross-sectional structure of the transverse member, and at least one reinforcement rib may be disposed below the gas inlet hole to horizontally divide the cross-sectional structure of the transverse member.

The pack side frame may be connected to end portions of a plurality of transverse members disposed parallel to each other in the forward and rearward direction of the battery pack, may include a transverse outlet configured to discharge gas, which has been introduced from the transverse members, in a transverse direction of the battery pack, and may include a longitudinal outlet configured to discharge the gas, which has been introduced from the transverse members, to a rear of the battery pack.

Each of the battery modules may include a fire-resistant material located between each pair of stacked battery cells, and the fire-resistant material may extend to be inserted into a detecting block to which electrode leads of the battery cells are coupled.

The fire-resistant material may include a cross-sectional structure in which a surface pressure pad layer is provided at the center portion and a fire-resistant layer is provided on each of first and second sides of the surface pressure pad layer.

An end portion of the fire-resistant material may extend through the detecting block to come into close contact with an internal surface of a module cover surrounding an external side of the detecting block.

A blocking cover may be disposed on an external side of the module cover, and the blocking cover may be formed in a panel shape including venting holes at corresponding locations between the adjacent fire-resistant materials.

The venting holes of the blocking cover may be provided to fluidically communicate with the gas inlet holes of the internal members.

Furthermore, to achieve the aspect as described above, a battery module for a vehicle battery pack, according to an exemplary embodiment of the present disclosure, may include a plurality of battery cells stacked in one direction, a detecting block to which electrode leads of the battery cells are coupled, and a plurality of fire-resistant materials located between the battery cells and extending to be inserted into the detecting block.

Each of the fire-resistant materials may include a cross-sectional structure in which a surface pressure pad layer is provided at the center portion and a fire-resistant layer is provided on each of first and second sides of the surface pressure pad layer.

Each of the fire-resistant materials may include a single-layer pad made of a heat-resistant silicone material.

An end portion of each of the fire-resistant materials may extend through the detecting block to come into contact with an internal surface of a module cover surrounding an external side of the detecting block.

A blocking cover may be disposed on an external side of the module cover, and the blocking cover may be formed in a panel shape including venting holes at corresponding locations between the adjacent fire-resistant materials.

The blocking cover may be made of an incombustible metal material.

The present disclosure may significantly improve the fire safety of a battery pack by providing a passage for independent and rapid discharge of gas released from a battery cell forming a battery module, so that fire is prevented from spreading to adjacent battery cells and adjacent battery modules.

The methods and apparatuses of the present disclosure have other features and advantages which will be apparent from or are set forth in more detail in the accompanying drawings, which are incorporated herein, and the following Detailed Description, which together serve to explain certain principles of the present disclosure.

### BRIEF DESCRIPTION OF THE DRAWINGS

FIG. 1 illustrates a lower case of a battery pack to which the present disclosure is applied;

FIG. 2 is a cross-sectional view taken along line II-II in FIG. 1;

FIG. 3 is a cross-sectional view taken along line III-III in FIG. 1;

FIG. 4 illustrates, by arrows, passages through which gas generated from battery cells may be vented in accordance with the present disclosure, with the battery modules accommodated in the same lower case as in FIG. 1

FIG. 5 illustrates a battery module accommodated in the lower case in FIG. 1;

FIG. 6 is an exploded view of some components in FIG. 5;

FIG. 7 is a cross-sectional view taken along line VII-VII in FIG. 5:

FIG. 8 is a cross-sectional view taken along line VIII-VIII in FIG. 7;

FIG. 9 illustrates another exemplary embodiment of a transverse member shown in the same cross section as in FIG. 2:

FIG. 10 is a cross-sectional view taken along line X-X in FIG. 1; and

FIG. 11 is a cross-sectional view taken along line XI-XI in FIG. 1.

It may be understood that the appended drawings are not necessarily to scale, presenting a somewhat simplified representation of various features illustrative of the basic principles of the present disclosure. The predetermined design features of the present disclosure as included herein, including, for example, specific dimensions, orientations, locations, and shapes will be determined in part by the particularly intended application and use environment.

In the figures, reference numbers refer to the same or equivalent portions of the present disclosure throughout the several figures of the drawing.

### DETAILED DESCRIPTION

Reference will now be made in detail to various embodiments of the present disclosure(s), examples of which are illustrated in the accompanying drawings and described below. While the present disclosure(s) will be described in conjunction with exemplary embodiments of the present disclosure, it will be understood that the present description is not intended to limit the present disclosure(s) to those exemplary embodiments of the present disclosure. On the other hand, the present disclosure(s) is/are intended to cover not only the exemplary embodiments of the present disclosure, but also various alternatives, modifications, equivalents and other embodiments, which may be included within the spirit and scope of the present disclosure as defined by the appended claims.

Hereinafter, embodiments included in the present specification will be described in detail with reference to the accompanying drawings, and the same or similar elements are provided the same and similar reference numerals, so duplicate descriptions thereof will be omitted.

The terms “module” and “unit” used for the elements in the following description are provided or interchangeably used in consideration of only the ease of writing the specification, and do not have distinct meanings or roles by themselves.

In describing the exemplary embodiments included in the present specification, when the detailed description of the relevant known technology is determined to unnecessarily obscure the gist of the present disclosure, the detailed description may be omitted. Furthermore, the accompanying drawings are provided only for easy understanding of the exemplary embodiments included in the present specification, and the technical spirit included herein is not limited to the accompanying drawings, and it should be understood that all changes, equivalents, or substitutes thereof are included in the spirit and scope of the present disclosure.

Terms including an ordinal number such as “first”, “second”, or the like may be used to describe various elements, but the elements are not limited to the terms. The above terms are used only for distinguishing one element from another element.

In the case where an element is referred to as being “connected” or “coupled” to any other element, it should be understood that another element may be provided therebetween, as well as that the element may be directly connected or coupled to the other element. In contrast, in the case where an element is “directly connected” or “directly coupled” to any other element, it should be understood that no other element is present therebetween.

A singular expression may include a plural expression unless they are definitely different in a context.

As used herein, the expression “include” or “have” are intended to specify the existence of mentioned features, numbers, steps, operations, elements, components, or combinations thereof, and should be construed as not precluding the possible existence or addition of one or more other features, numbers, steps, operations, elements, components, or combinations thereof.

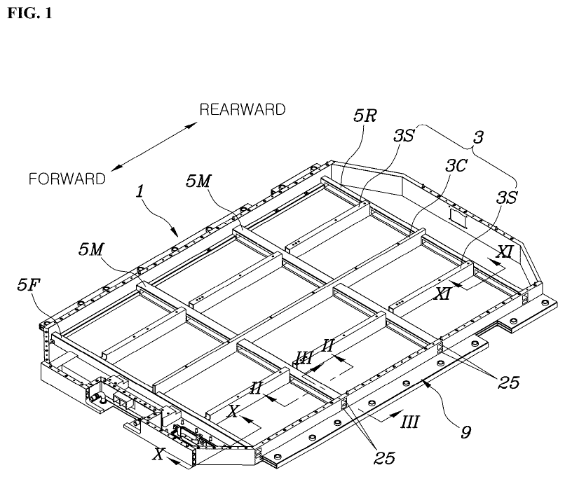

FIG. 1 illustrates a lower case 1 for a battery pack according to an exemplary embodiment of the present disclosure, wherein a plurality of internal members are disposed in the lower case 1.

The internal members include a longitudinal member 3, which is elongated in the forward and rearward direction of the battery pack, and a transverse member 5, and a plurality of battery modules 7 are accommodated in the lower case 1 while isolated from each other by the internal members.

An upper cover is coupled to the top side of the lower case 1 to form the battery pack together with the lower case 1, and is configured to isolate the battery modules 7 inside from the outside thereof.

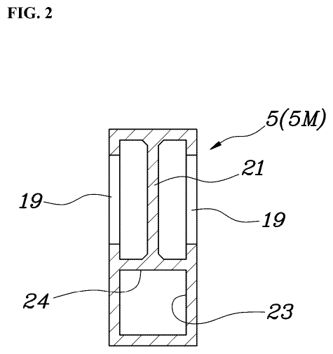

FIG. 2 is a cross-sectional view taken along line II-II in FIG. 1, and illustrates the cross-section of the transverse member 5 of the plurality of internal members provided in the lower case 1.

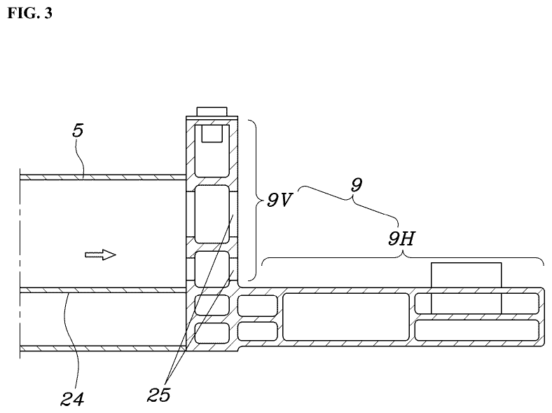

FIG. 3 is a cross-sectional view taken along line III-III in FIG. 1, and illustrates the cross-section of a pack side frame 9 for receiving gas from the transverse member 5 and discharging the gas to the outside thereof.

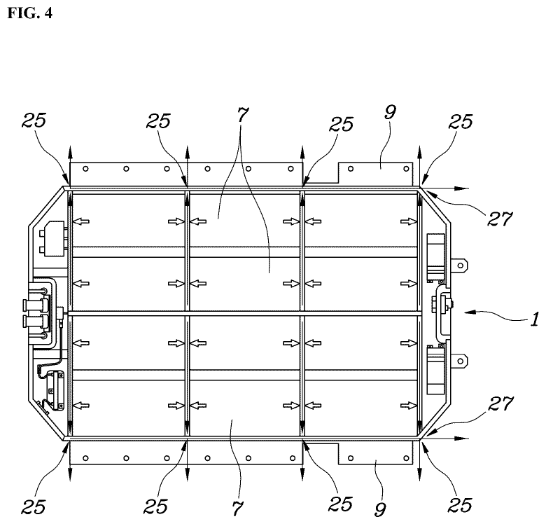

FIG. 4 illustrates, by arrows, flow channels through which gas generated from battery cells 11 may be vented in accordance with the present disclosure, with the battery modules 7 accommodated in the same lower case 1 as in FIG. 1.

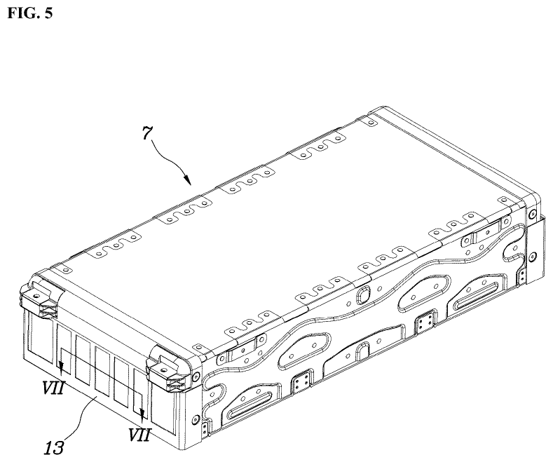

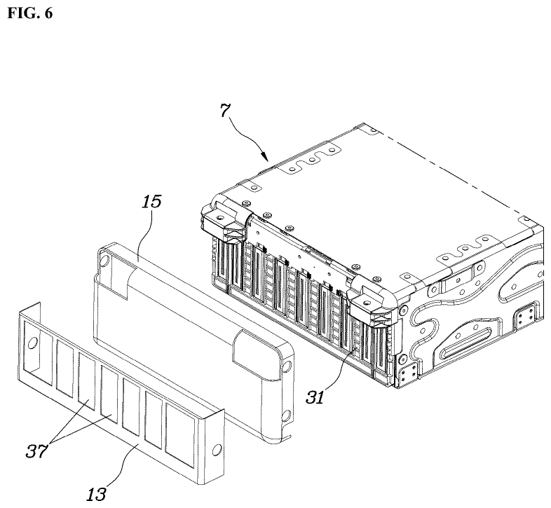

FIG. 5 is a three-dimensional view of a battery module 7 accommodated in the lower case 1 of FIG. 1, and FIG. 6 is an exploded view of a blocking cover 13 and a module cover 15 in FIG. 5.

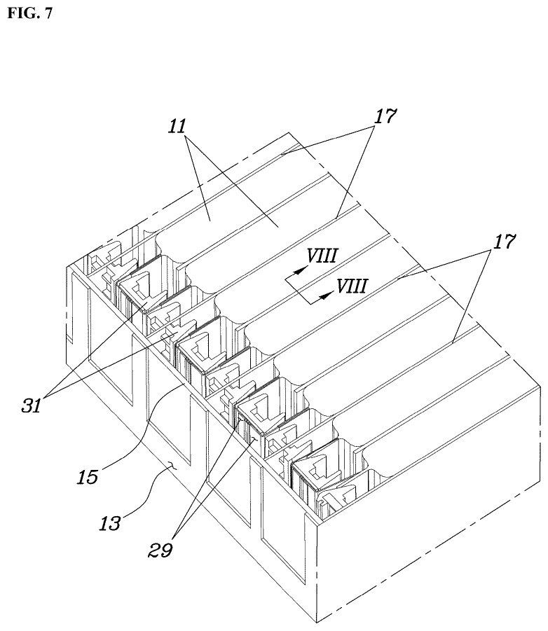

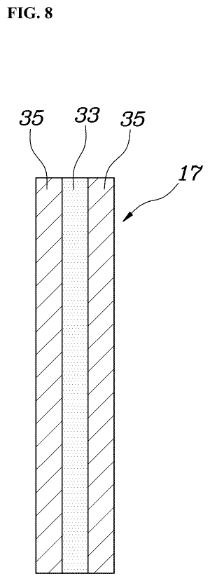

FIG. 7 is a cross-sectional view taken along line VII-VII in FIG. 5 and illustrates in detail a stacked state of battery cells 11 of the battery module 7 and a disposed state of a fire-resistant material 17. FIG. 8 is a cross-sectional view taken along line VIII-VIII in FIG. 7, and illustrates a cross-sectional structure of the fire-resistant material 17.

Referring to FIG. 1, FIG. 2, FIG. 3, FIG. 4, FIG. 5, FIG. 6, FIG. 7, and FIG. 8, a gas venting structure for a vehicle battery pack, according to an exemplary embodiment of the present disclosure, includes a lower case 1 configured to accommodate a plurality of battery modules 7 in a plane, a plurality of internal members provided to separate the battery modules 7 accommodated in the lower case 1 from each other, gas inlet holes 19 formed in some of the internal members to allow gas released from a battery cell 11 of each of the battery modules 7 to be introduced therethrough, and an external member disposed to receive the gas from end portions of the internal members including the gas inlet holes 19 and discharge the gas outside thereof.

In other words, according to an exemplary embodiment of the present disclosure, when gas is released from one of the battery cells 11 forming the battery modules 7 due to a fire or the like, the gas may be rapidly and smoothly discharged to the outside of the battery pack through the external member after moving through the internal members via the gas inlet holes 19.

In an exemplary embodiment of the present disclosure, the internal members include a longitudinal member 3 disposed to be elongated in a forward and rearward direction of the battery pack and a transverse member 5 disposed to be elongated in a transverse direction of the battery pack, the gas inlet holes 19 are formed in the transverse member 5, and the external member disposed to receive the gas from an end portion of the transverse member 5 and discharge the gas outside is a pack side frame 9.

The pack side frame 9 is disposed on each of both sides of the battery pack to form an outline of the battery pack and function as a frame to which multiple mounting bolts, which are to be coupled to the body of a vehicle, are fastened when the battery pack is mounted to the vehicle. In an exemplary embodiment of the present disclosure, the pack side frame 9 also performs the function of discharging gas transferred through the transverse member 5 to the outside thereof, as described above.

As illustrated in FIG. 2, a cross-sectional structure of the transverse member 5 in a direction perpendicular to a longitudinal direction thereof includes a shape in which the gas inlet holes 19 are formed to be symmetrical to each other at first and second sides and an intermediate partition wall 21 is disposed to separate the two gas inlet holes 19 from each other.

Thus, when gas is generated in one of battery modules 7 disposed at both sides with the transverse member 5 interposed therebetween, the intermediate partition wall 21 of the transverse member 5 prevents the gas from spreading to the other battery module 7 opposite to the transverse member 5, and guides the gas to flow through the internal space of the transverse member 5.

Thus, the configuration described above may effectively prevent fire from spreading to adjacent battery modules 7.

Furthermore, the cross-sectional structure of the transverse member 5 in the direction perpendicular to the longitudinal direction thereof may include a closed cross-section 23 forming a separate space under the intermediate partition wall 21.

Wires or the like for transmitting electrical signals may be inserted into the space formed by the closed cross-section 23. In the instant case, a component inserted and disposed in the space formed by the closed cross-section 23 may not be affected by the gas discharged from the battery cell 11, and thus may be more securely protected.

Various types of transverse members 5 may be used.

That is, as illustrated in FIG. 1, the transverse members 5 may be divided into a frontmost transverse member 5F disposed at the frontmost side of the battery pack, a rearmost transverse member 5R disposed at the rearmost side, and an intermediate transverse member 5M disposed between the frontmost transverse member 5F and the rearmost transverse member 5R.

In the case of the intermediate transverse member 5M, as illustrated in FIG. 2, the intermediate partition wall 21 may be elongated in an upward and downward direction in a center portion of the cross-sectional structure of the transverse member, and at least one reinforcement rib 24 may be elongated in a horizontal direction under the intermediate partition wall 21.

The gas inlet holes 19 are formed to be symmetrical to each other at both sides of the intermediate partition wall 21, so that gas released from battery modules 7 disposed at both sides of the intermediate transverse member 5M may be introduced independently.

Furthermore, the reinforcement rib 24 may reinforce the stiffness of the intermediate transverse member 5M and form the closed cross-section 23 as described above.

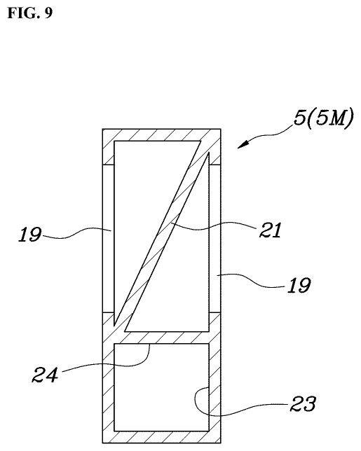

FIG. 9 illustrates another exemplary embodiment of the intermediate transverse member 5M, which includes a structure in which a least one reinforcement rib 24 is elongated in a horizontal direction under the intermediate partition wall 21, and the intermediate partition wall 21 is shaped as a diagonal line bisecting a portion above the reinforcement rib 24 in the cross-sectional structure of the transverse member.

In the intermediate transverse member 5M including such a structure, the gas inlet holes 19 are formed to be symmetrical to each other at both sides of the intermediate partition wall 21, so that gas released from battery modules 7 disposed at both sides of the intermediate transverse member 5M may be introduced independently.

Furthermore, the reinforcement rib 24 may reinforce the stiffness of the intermediate transverse member 5M and form the closed cross-section 23 as described above.

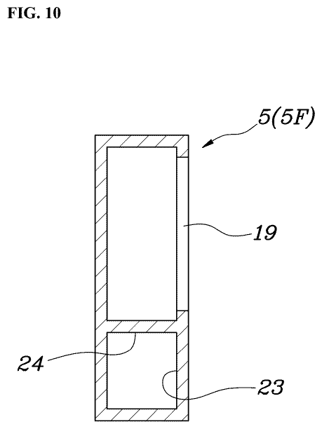

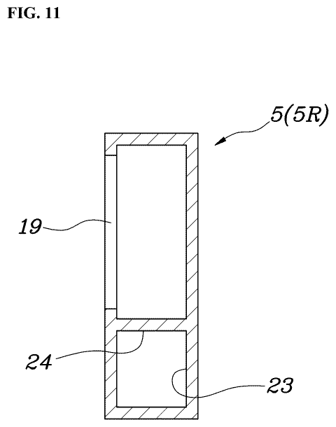

FIG. 10, and FIG. 11 illustrate cross-sections of the frontmost transverse member 5F and the rearmost transverse member 5R, respectively. In the cross-sections of the frontmost transverse member 5F and the rearmost transverse member 5R, a gas inlet hole 19 is formed in one side, and a reinforcement rib 24 is disposed below the gas inlet hole 19 to horizontally divide each of the cross-sectional structure of the transverse members.

That is, the frontmost transverse member 5F includes a gas inlet hole 19 in the rear side thereof, and the rearmost transverse member 5R includes a gas inlet hole 19 in the front side thereof.

Because each of the frontmost transverse member 5F and the rearmost transverse member 5R do not need to include the intermediate partition wall 21, the flow cross-sectional area of gas introduced through the gas inlet hole 19 may be greater than that of the intermediate transverse member 5M, facilitating the flow and discharge of the gas introduced from a battery module 7.

In an exemplary embodiment of the present invention, the frontmost transverse member 5F and the rearmost transverse member 5R shown in FIG. 10, and FIG. 11 may include the intermediate partition wall 21 shaped as a diagonal line bisecting a portion above the reinforcement rib 24 in the cross-sectional structure of the transverse member as shown in FIG. 9.

A plurality of transverse members 5 may be spaced apart parallel to each other in the forward and rearward direction of the battery pack, and the pack side frame 9 may be elongated in the forward and rearward direction of the battery pack to be connected to ends of the plurality of transverse members 5.

The pack side frame 9 may include a transverse outlet 25 for discharging gas introduced from the transverse members 5 in the transverse direction of the battery pack, and may include a longitudinal outlet 27 for discharging the gas introduced from the transverse members 5 to a rear of the battery pack.

Therefore, as illustrated in FIG. 4, the gas generated in the battery module 7 may move through the transverse member 5 and be discharged to the side or rear of the battery pack through the pack side frame 9.

In an exemplary embodiment of the present disclosure, the pack side frame 9 includes a vertical portion 9V directly connected to the end portions of the plurality of transverse members 5 and a horizontal portion 9H protruding horizontally from the vertical portion 9V to sides of the battery pack, and the transverse outlet 25 is formed in the vertical portion 9V.

As illustrated in FIG. 3, the reinforcement rib 24 of the transverse member 5 is disposed at a height at which the reinforcement rib 24 is aligned with the horizontal portion 9H, to support a load externally applied through the horizontal portion 9H.

Thus, in the event of a side impact accident of a vehicle, an impact load acting from the side of the battery pack may be effectively supported by the horizontal portion 9H of the pack side frame 9 and the reinforcement ribs 24 of the transverse member 5, enabling more effective protection of the battery modules 7 accommodated in the battery pack.

As illustrated in FIGS. 1 and 4, the longitudinal member 3 may include a center longitudinal member 3C provided in a center portion of the battery pack, and side longitudinal members 3S provided to be spaced apart on both sides from the center longitudinal member 3C.

That is, the center longitudinal member 3C is provided in the center portion of the battery pack along a forward and rearward direction and elongated across the entire battery pack, and the transverse members 5 are provided to be symmetrically aligned with each other on first and second sides with respect to the center longitudinal member 3C.

The center longitudinal member 3C is provided to seal end portions of the transverse members 5 on the central side of the battery pack so that gas generated by a battery module 7 disposed on one side of the battery pack with respect to the center longitudinal member 3C is prevented from moving to the other side of the battery pack.

For example, when gas is released from a battery module 7 disposed on the left side of the center longitudinal member 3C due to a fire or the like, the gas introduced through a gas inlet hole 19 of a transverse member 5 disposed on the left side of the center longitudinal member 3C flows only to the left side of the battery pack and is discharged to the outside through a pack side frame 9 disposed on the left side of the battery pack, and cannot move to the right side of the center longitudinal member 3C, thus effectively preventing the spread of fire to a battery module 7 disposed on the right side of the battery pack.

Each of the battery modules 7 includes a fire-resistant material 17 located between each pair of stacked battery cells 11, and the fire-resistant material 17 extends to be inserted into a detecting block 31 to which electrode leads 29 of the battery cells 11 are coupled.

As illustrated in FIG. 8, the fire-resistant material 17 may include a cross-sectional structure in which a surface pressure pad layer 33 is provided at the center portion and a fire-resistant layer 35 on each of both sides of the surface pressure pad layer 33.

The fire-resistant layer 35 may be made of a material such as MICA.

Therefore, in a battery module 7 formed by repeatedly superimposing battery cells 11 and fire-resistant materials 17 as described above, the surface pressure of each battery cell 11 may be formed and maintained evenly and properly, and even when a fire occurs in an adjacent battery cell 11, the fire will not spread well.

The fire-resistant material 17 may also include a single-layer pad made of a heat-resistant silicone material. The heat-resistant silicone pad includes a slight elasticity of its own, which acts to form an even surface pressure between the battery cells 11, while also performing the function of preventing the spread of fire.

In an exemplary embodiment of the present disclosure, an end portion of the fire-resistant material 17 extends through the detecting block 31 to come into close contact with an internal surface of a module cover 15 surrounding an external side of the detecting block 31.

Furthermore, a blocking cover 13 is disposed on an external side of the module cover 15, and the blocking cover 13 is formed in a panel shape including venting holes 37 at corresponding locations between adjacent fire-resistant materials 17.

For reference, the module cover 15 is made of a material which may be easily deformed by heat, such as a plastic resin, so that under normal circumstances, the module cover 15 functions as a simple cover to cover the external periphery of the battery module 7, but when high-temperature gas is discharged due to a fire or the like in the battery cell 11, the module cover 15 is melted by the gas and easily perforated to fluidically communicate with the venting holes 37.

Thus, when high-temperature gas is released due to fire in one of battery cells 11 forming a battery module 7, the gas is not introduced into an adjacent battery cell 11 by the fire-resistant material 17, and is discharged through the venting holes 37 of the blocking cover 13 after perforating the module cover 15.

That is, when gas is released from one battery cell, the gas is discharged independently from each unit of the battery cells 11 separated by the blocking cover 13 and the fire-resistant material 17, and does not spread to the units of the adjacent battery cells 11.

Furthermore, the venting holes 37 of the blocking cover 13 are provided to fluidically communicate with the gas inlet holes 19 of the internal members, so that the gas discharged through the venting holes 37 of the blocking cover 13 may be rapidly discharged to the outside of the battery pack through the internal members and the pack side frame 9.

The blocking cover 13 may be made of an incombustible metal material, and the module cover 15 may be made of a plastic resin or the like which may be easily melted by high-temperature gas.

Therefore, the gas venting structure for a vehicle battery pack according to an exemplary embodiment of the present disclosure may reduce or prevent the phenomenon of thermal runaway of the battery pack by independently, immediately, and smoothly discharging high temperature gas generated from each of the battery cells 11 forming each of the battery modules 7 due to a fire or the like to the outside of the battery pack while preventing the spread of the gas to an adjacent battery cell 11 or an adjacent battery module 7.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The term “and/or” may include a combination of a plurality of related listed items or any of a plurality of related listed items. For example, “A and/or B” includes all three cases such as “A”, “B”, and “A and B”.

In the present specification, unless stated otherwise, a singular expression includes a plural expression unless the context clearly indicates otherwise.

In exemplary embodiments of the present disclosure, “at least one of A and B” may refer to “at least one of A or B” or “at least one of combinations of at least one of A and B”. Furthermore, “one or more of A and B” may refer to “one or more of A or B” or “one or more of combinations of one or more of A and B”.

In the exemplary embodiment of the present disclosure, it should be understood that a term such as “include” or “have” is directed to designate that the features, numbers, steps, operations, elements, parts, or combinations thereof described in the specification are present, and does not preclude the possibility of addition or presence of one or more other features, numbers, steps, operations, elements, parts, or combinations thereof.

The foregoing descriptions of specific exemplary embodiments of the present disclosure have been presented for purposes of illustration and description. They are not intended to be exhaustive or to limit the present disclosure to the precise forms disclosed, and obviously many modifications and variations are possible in light of the above teachings. The exemplary embodiments were chosen and described in order to explain certain principles of the invention and their practical application, to enable others skilled in the art to make and utilize various exemplary embodiments of the present disclosure, as well as various alternatives and modifications thereof. It is intended that the scope of the present disclosure be defined by the Claims appended hereto and their equivalents.

What is claimed is:

1. A gas venting structure for a battery pack, the gas venting structure comprising:
a lower case accommodating a plurality of battery modules;
a plurality of internal members provided to separate the battery modules accommodated in the lower case from each other;
gas inlet holes formed in a predetermined number of internal members among the plurality of internal members to allow gas released from a battery cell of each of the battery modules to be introduced therethrough; and
an external member disposed to receive the gas from end portions in the predetermined number of the internal members including the gas inlet holes and discharge the gas outside of the external member.

2. The gas venting structure of claim 1,
wherein the internal members include a longitudinal member disposed to be elongated in a forward and rearward direction of the battery pack and a transverse member disposed to be elongated in a transverse direction thereof,
wherein the gas inlet holes are formed in the transverse member, and
wherein the external member disposed to receive the gas from an end portion of the transverse member and discharge the gas outside is a pack side frame.

3. The gas venting structure of claim 2, wherein a cross-sectional structure of the transverse member in a direction perpendicular to a longitudinal direction thereof includes the gas inlet holes formed to be symmetrical to each other at first and second sides and an intermediate partition wall disposed to separate the symmetrically formed gas inlet holes from each other.

4. The gas venting structure of claim 3, wherein the cross-sectional structure of the transverse member in the direction perpendicular to the longitudinal direction thereof includes a closed cross-section forming a separate space under the intermediate partition wall.

5. The gas venting structure of claim 3,
wherein the intermediate partition wall is elongated in an upward and downward direction in a center portion of the cross-sectional structure of the transverse member, and
wherein at least one reinforcement rib is elongated in a horizontal direction under the intermediate partition wall.

6. The gas venting structure of claim 3,
wherein at least one reinforcement rib is elongated in a horizontal direction under the intermediate partition wall, and
wherein the intermediate partition wall is formed to diagonally bisect a portion above the at least one reinforcement rib in the cross-sectional structure of the transverse member.

7. The gas venting structure of claim 3,
wherein a reinforcement rib is elongated in a horizontal direction under the intermediate partition wall of the transverse member,
wherein a plurality of transverse members are spaced apart parallel to each other in the forward and rearward direction of the battery pack,
wherein the pack side frame is elongated in the forward and rearward direction of the battery pack to be connected to end portions of the plurality of transverse members,
wherein the pack side frame includes a vertical portion directly connected to the end portions of the plurality of transverse members and a horizontal portion protruding horizontally from the vertical portion to sides of the battery pack, and
wherein the reinforcement rib of the transverse member is disposed at a height at which the reinforcement rib is aligned with the horizontal portion, to support a load externally applied through the horizontal portion.

8. The gas venting structure of claim 3,
wherein the longitudinal member includes a center longitudinal member provided in a center portion of the battery pack, and side longitudinal members provided to be spaced apart on first and second sides from the center longitudinal member,
wherein the transverse member is provided in plural, and the plurality of transverse members are symmetrically aligned with each other on the first and second sides with respect to the center longitudinal member, and
wherein the center longitudinal member is provided to seal the end portions of the transverse members.

9. The gas venting structure of claim 2, wherein in a cross-sectional structure of the transverse member in a direction perpendicular to a longitudinal direction thereof,
a gas inlet hole is formed in at least one side of a cross-sectional structure of the transverse member; and
at least one reinforcement rib is disposed below the gas inlet hole to horizontally divide the cross-sectional structure of the transverse member.

10. The gas venting structure of claim 2,
wherein the pack side frame is connected to end portions of a plurality of transverse members disposed parallel to each other in the forward and rearward direction of the battery pack,
wherein the pack side frame includes a transverse outlet configured to discharge the gas, which has been introduced from the transverse members, in a transverse direction of the battery pack, and
wherein the pack side frame includes a longitudinal outlet configured to discharge the gas, which has been introduced from the transverse members, to a rear of the battery pack.

11. The gas venting structure of claim 1,
wherein each of the battery modules includes a fire-resistant material located between each pair of stacked battery cells, and
wherein the fire-resistant material extends to be inserted into a detecting block to which electrode leads of the battery cells are coupled.

12. The gas venting structure of claim 11, wherein the fire-resistant material includes a cross-sectional structure in which a surface pressure pad layer is provided at a center portion of the cross-sectional structure and a fire-resistant layer is provided on each of first and second sides of the surface pressure pad layer.

13. The gas venting structure of claim 11, wherein the fire-resistant material includes a single-layer pad made of a heat-resistant silicone material.

14. The gas venting structure of claim 11, wherein an end portion of the fire-resistant material extends through the detecting block to come into contact with an internal surface of a module cover surrounding an external side of the detecting block.

15. The gas venting structure of claim 11,
wherein a blocking cover is disposed on an external side of the module cover, and
wherein the blocking cover includes venting holes at corresponding locations between adjacent fire-resistant materials.

16. The gas venting structure of claim 15, wherein the venting holes of the blocking cover are provided to fluidically communicate with the gas inlet holes of the predetermined number of internal members.

17. A battery module for a battery pack, the battery module comprising:
a plurality of battery cells stacked in one direction thereof;
a detecting block to which electrode leads of the battery cells are coupled; and
a plurality of fire-resistant materials located between the battery cells and extending to be inserted into the detecting block.

18. The battery module of claim 17, wherein each of the fire-resistant materials includes a cross-sectional structure in which a surface pressure pad layer is provided at a center portion of the cross-sectional structure and a fire-resistant layer is provided on each of first and second sides of the surface pressure pad layer.

19. The battery module of claim 17, wherein an end portion of each of the fire-resistant materials extends through the detecting block to come into contact with an internal surface of a module cover surrounding an external side of the detecting block.

20. The battery module of claim 17,
wherein a blocking cover is disposed on an external side of the module cover;
wherein the blocking cover includes venting holes at corresponding locations between adjacent fire-resistant materials, and
wherein the blocking cover is made of an incombustible metal material.
